(19) United States
(12) Patent Application Publication
(10) Pub. No.: US 2026/0178762 A1
(43) Pub. Date: Jun. 25, 2026

(54) MANAGING FILE TRANSFER WITH HIDDEN OR SECURE PROPERTIES ACROSS CONNECTED DEVICES

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 18/999,381

(22) Filed: Dec. 23, 2024

(51) Int. Cl. G06F 21/62

(52) U.S. Cl. CPC G06F 21/6218

(57) ABSTRACT

A method of discreetly transferring selected content from a first electronic device to a communicatively coupled second communication device. The method includes, in response to a request to transfer a selected content from the first electronic device to the second electronic device, determining whether the selected content is stored securely. The method includes, in response to determining that the selected content is stored securely, determining a manner in which the content is secured. The method includes transferring the selected content via a discreet transfer process that maintains the security of the content during transfer from the electronic device to the second electronic device. The method includes securely storing the selected content at the second electronic device in a same manner in which the content was stored at the electronic device prior to being transferred.

### BACKGROUND

### 1. Technical Field

The present disclosure generally relates to secure electronic file storage, and more specifically to transferring secure electronic files between devices.

### 2. Description of the Related Art

File transfer between commonly owned devices or devices sharing a common network is a common experience that has become virtually seamless. The speed and ease with which file owners can transmit their files to new devices often lulls the file owner into a false sense of security, resulting in the owner often neglecting to take basic measures to ensure that the files are transferred securely or securely stored after transit. This can lead to an increase in unauthorized access of transferred files in both private and business settings.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement discreet transfer and secure storage of sensitive files, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 depicts an example component makeup of a second electronic device communicatively connected to the first electronic device, operative to implement discreet transfer and secure storage of sensitive files, according to one or more embodiments;

FIG. 3A illustrates an example file transfer scenario presenting exemplary discreet content transfer mode (DCTM) whereby the electronic device transfers targeted content to the second electronic device and stores the targeted content at the second electronic device without special handling, according to one or more embodiments;

FIG. 3B illustrates another example file transfer scenario presenting exemplary DCTM whereby the electronic device securely transfers targeted content, stored with password protection at the electronic device, to the second electronic device and triggers storage of the targeted content at the second electronic device with password protection, according to one or more embodiments;

FIG. 3C illustrates another example file transfer scenario presenting exemplary DCTM whereby the electronic device securely transfers the targeted content to the second electronic device and triggers storage of the targeted content in a manner different from the manner in which the selected content was stored at the electronic device, according to one or more embodiments;

FIG. 4 is a flow diagram presenting a method for discreetly transferring targeted content having been determined to be securely stored at a first electronic device and securely storing the content at a second electronic device, according to one or more embodiments; and

FIG. 5 depicts a flow diagram of another method for discretely transferring targeted content having been determined to be securely stored at a first electronic device and securely storing the content at a second electronic device, according to one or more embodiments.

### DETAILED DESCRIPTION

According to aspects of the present disclosure, an electronic device, a method, and a computer program product enable secure transfer and secure storage of protected files at the destination storage device. More specifically, a first electronic device determines the security status of a file or folder stored on the first electronic device that is to be transferred/moved or copied to a second electronic device. The first electronic device securely transmits a copy of the target file/folder from the first electronic device to a communicatively connected second electronic device and triggers the second electronic device to store the target file/folder in a manner consistent with the manner in which the target file/folder was stored at the first electronic device prior to transfer in order to maintain the security of the file stored at the second electronic device.

Transferring files between electronic devices directly or via network connections often results in incomplete or absent security protocols during transfer of the files and/or when storing the files at the selected destination. Apps such as Signal, Telegram, or WhatsApp, offer end-to-end encryption for messages, sometimes with the option to send encrypted files as well, but this option merely provides encryption during transmission and does not support encryption of the transferred files at the destination device in accordance with (or similar to) the security status of the file at the original/originating device. Solutions such as Veracrypt and BoxCryptor allow on-the-fly (OTF) encryption of storage, but such encryption uniformly applies the same level of encryption to all files on the given storage media. Cloud storage providers such as Google Drive, Dropbox, or Microsoft OneDrive offer encrypted storage and allow easy file transfer between devices with internet access, but such cloud storage creates a copy of each file as-is at the transfer destination. The present innovation addresses the above issues by assessing the security status of the file at the original device, securely transmitting the file to a destination device, and storing the file at the destination device with security that is substantially similar to the security that was applied to the file stored at the original device.

According to one embodiment, the electronic device includes a display embedded in a user accessible surface of the electronic device, a communications subsystem comprising an interface that enables the electronic device to communicatively connect via a wireless connection to a second electronic device, a memory having stored thereon a secure content transfer manager (SCTM) for maintaining security of securely stored content transferred between connected devices, and at least one processor communicatively coupled to the display, the communications subsystem, and the memory. The at least one processor executes program code of the secure content transfer manager, and is configured to cause the electronic device to, in response to a request to transfer a selected content to the second electronic device, determine whether the selected content is stored securely, and in response to determining that the selected content is stored securely determine a manner in which the content is secured. The processor is further configured to cause the electronic device to transfer the selected content via a discreet transfer process that maintains the security of the content during the transfer from the electronic device to the second electronic device. The processor is further configured to cause the electronic device to securely store the selected content at the second electronic device in the same secure manner in which the content was originally stored at the electronic device at the time of transfer.

Additionally, according to one aspect of the disclosure, a method is disclosed for securely storing selected content at a second electronic device with similar security as was applied to the content stored at an originating electronic device prior to the selected content being transferred. The method includes, in response to a request to transfer a selected content from the originating electronic device to a second electronic device, determining whether the selected content is stored securely, and in response to determining that the selected content is stored securely, determining a manner in which the content is secured, transferring the selected content via a discreet transfer process that maintains the security of the content during transfer from the electronic device to the second electronic device, and securely storing the selected content at the second electronic device using the same security as was used to store the content at the electronic device, at the time the content is being transferred.

Also disclosed is a computer program product comprising a non-transitory computer readable medium having computer program product instructions, that when executed by a processor of an electronic device communicatively connected via a wireless connection to a second electronic device, configure the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

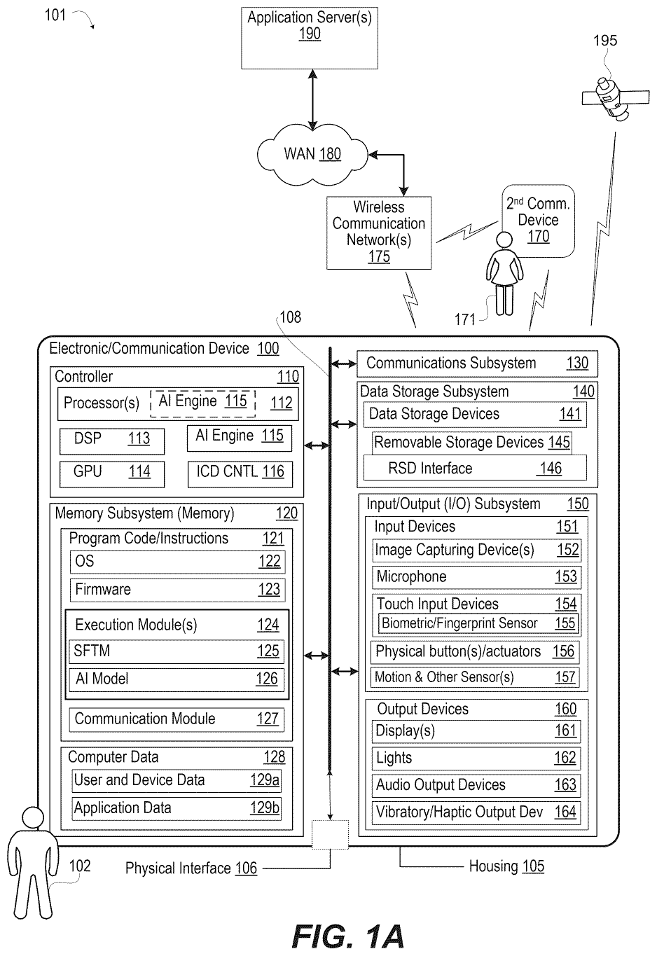

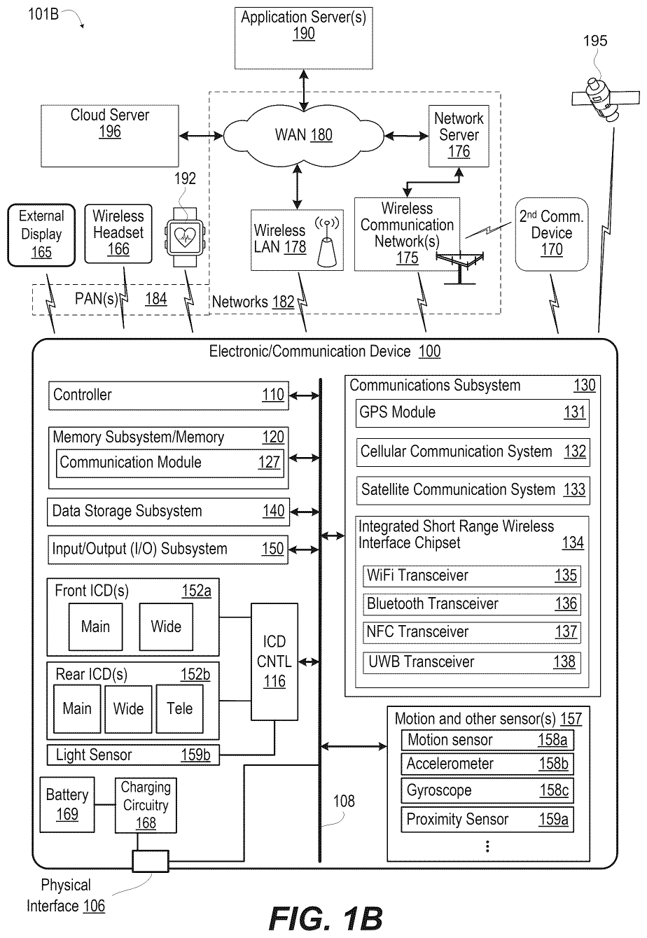

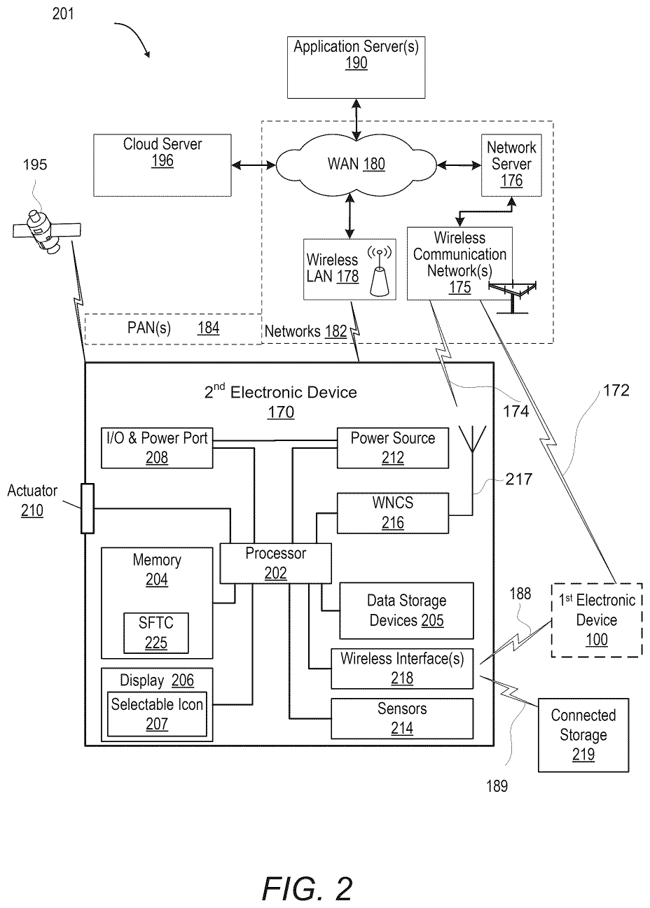

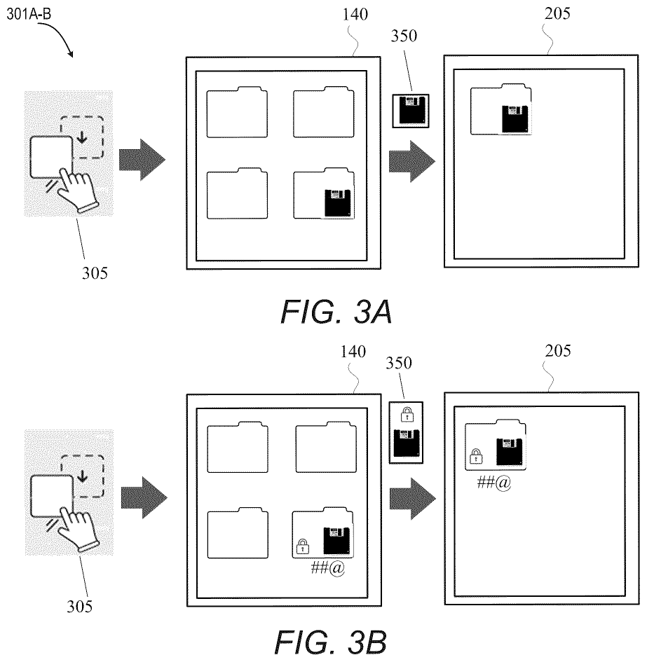

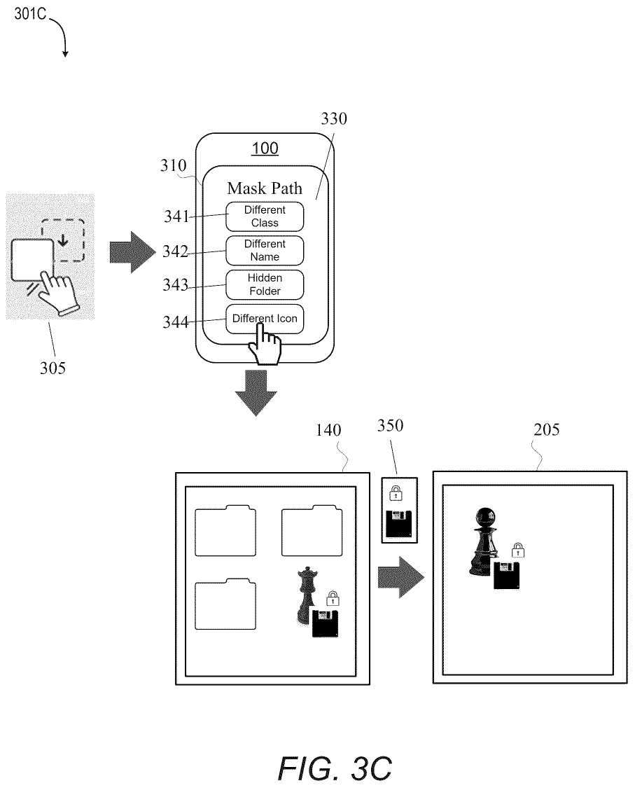

Referring now to the figures and beginning with FIG. 1A, there is illustrated a block diagram of an example electronic device 100 in a communication environment 101 and having hardware and software components, which enable the features of the present disclosure to implement discreet transfer and secure storage of sensitive files, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. In the described embodiments, reference is made to a first electronic device and a second electronic device. For purposes of the description of the various embodiments herein, FIG. 1 (FIG. 1A and FIG. 1B) is presented as/from the perspective of the first electronic device, which is the device which initiates discreet content (e.g. files and folders) sharing between the first and second electronic devices. FIG. 2 is presented as the second electronic device, which receives and stores content from the first device after a secure transfer between the two electronic devices. Prior to content transfer, the existing security features applied to the content at the first electronic device are determined. Following the transfer, secure storage of the content is completed at the second electronic device to be consistent with the existing security features applied to the content at the first electronic device. Discreet content transfer is normally an automated process. FIGS. 3A-3D depict the functionality of discreet content transfer being carried out in response to a manual selection via a user interface. In describing discreet content transfer herein, reference is made to content (files or folders stored at the first device). The file and folders or copies of the files or folders stored at electronic device 100 are transferred to the second device 170 and all referred to as content for the sake of simplicity.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide the various features of the disclosure. Execution module(s) 124 include, without limitation, secure content transfer manager (SCTM) 125, which provides the features and operating functionality of the disclosed embodiments when the corresponding program instructions of SCTM 125 are processed by/within processor 112/controller 110. Specifically, SCTM 125 provides program instructions for completing the transferring/copying of securely stored content between devices via secure transfer and subsequent secure storage in keeping with the security features applied to the content at the originating device, first electronic device 100.

Execution module(s) 124 further include AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within SCTM 125 and is trained to support the AI features of SCTM 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, SCTM 125 can include program instructions that cause or configure processor 112 to cause electronic device 100 to, in response to a request to transfer a selected content to the second electronic device 170, determine whether the selected content is stored securely. The controller 110, in response to determining that the selected content is stored securely, causes the electronic device 100 to determine a manner in which the content is secured. The controller 110 is further configured to cause the electronic device 100 to transfer the selected content via a discreet transfer process that maintains the security of the content during the transfer from the electronic device 100 to the second electronic device 170. The controller 110 is further configured to cause the electronic device 100 to trigger secure storage of the selected content at the second electronic device 170 in the same manner in which the content was stored at the electronic device 100 prior to being transferred.

In one or more embodiments, the controller 110, in response to determining that the selected content is stored securely, may cause the electronic device 100 to fetch metadata associated with the selected content. The controller 112 is further configured to cause the electronic device 100 to assign a tag to the metadata, indicating that the selected content is securely stored. The controller 110 is further configured to cause the electronic device 100 to embed additional metadata within a transfer instruction that is provided with the discreet transfer process to be used for securely storing the selected content at the second electronic device 170. The controller 110 is further configured to cause the electronic device 100 to transfer the selected content along with the transfer instruction. The transfer instruction triggers the second electronic device 170 to extract the additional metadata from the transfer instruction and to securely store the selected content using the extracted additional metadata to identify a manner of security to apply to the content at the second electronic device 170.

In a further embodiment, the controller 110 is further configured to cause the electronic device 100 to encrypt the selected content with a password prior to the transfer, transmit the password within additional metadata or as a separate instruction to the second electronic device 170 to cause the second electronic device 170 to decrypt the selected content following receipt of the transfer of the selected content. Alternatively, the first electronic device 100 may send the password to a cloud server 196 communicatively connected to the first electronic device 100 and the second electronic device 170. In at least one embodiment, in response to determining that the selected content is not stored securely, the processor 112 is configured to cause the electronic device 100 to transfer the selected content via a normal transfer process that triggers the second electronic device 170 to store the selected content as is.

In at least one embodiment, to transfer the content via the discreet transfer process, the processor 112 configures the electronic device 100 to securely transfer the selected content from the electronic device 100 to the second electronic device 170 by implementing on-the-fly (OTF) encryption. The processor 112 is further configured to cause the electronic device 100 to withhold visible notification of the transfer and withhold presentation of a progress status and a completion status of the transfer.

In at least one embodiment, the processor 112 is further configured to cause the electronic device 100 to, following the transfer of the content from the electronic device 100 to the second electronic device 170, remove a record of the transfer from the electronic device 100 to the second electronic device 170 from a history maintained in memory 120 of the electronic device 100. In at least one embodiment, the processor 112 is further configured to cause the electronic device 100 to provide instructions to the second electronic device 170 to trigger the second electronic device 170 to hide the selected content or a portion thereof in a storage device 205 at the second electronic device 170 following receipt of the selected content from the electronic device 100. In at least one embodiment, the processor 112 is further configured to cause the electronic device 100 to, in securely storing the selected content at the second device 170, obscure the location of the content by masquerading content as a different type or class of content. In at least one embodiment, the controller 110 is further configured to cause the electronic device 100 to, in triggering secure storage of the selected content at the second device 170, obscure the location of the content by assigning a different name to transferred content at the second electronic device 170 than was used to designate the content at the electronic device 100. Other features provided by SCTM 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of SCTM 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays.

Vibration device 164 can cause electronic device 100 to vibrate or shake when activated. Vibration device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of SCTM 125 and/or access to other applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIG. 2 depicts an example component makeup of a second electronic device 170 communicatively connected to the first electronic device 100, operative to enable implementation of discreet transfer of secure content from the first electronic device 100 and to securely store the secure content using similar security as at the first electronic device 100, according to one or more embodiments.

Second electronic device 170 can, in some embodiments, be an implementation of electronic device 100, having similar components and/or functionality. Second electronic device 170 includes processor (or controller) 202, which is communicatively coupled to memory 204, data storage device(s) 205, display 206, input/output (I/O) and power port 208, physical input buttons/actuator 210 and sensors 214. Processor 202 is further communicatively coupled to WNCS 216 having attached antenna 217, to wireless interface 218, and to power source 212. Second electric device 170 includes display 206, which can incorporate a tactile, touch screen interface (not shown) that can receive user tactile/touch input. I/O and power port 208 may be configured to interface with any number of devices including, but not limited to USB enabled devices. Sensors 214 may include, but are not limited to an accelerometer, a gyroscope, an ambient light sensor, a thermometer, a barometer, a fingerprint sensor, and a proximity sensor. WNCS 216, via antenna(s) 217, and wireless interface(s) 218 collectively provide wireless communications subsystem of second electronic device 170. Wireless interface(s) 218 may connect second electronic device 170 to first electronic device 100 via short range wireless connection directly (188) or through local wireless network (189a-189b). The functionality of network server 176 and cellular wireless communication network 175 is substantially similar to that described in FIG. 1.

Controller 202, communication subsystem 225, and computer data 240 of second communication device 170 can be substantially similar to controller 110, communications subsystem 130, and computer data 128 of electronic device 100 and perform functionality consistent with the description of these elements in relation to FIG. 1A and FIG. 1B. Networks 182 including CWCN 175, WLAN 178, and Wide Area Network (WAN) 180 likewise perform functionality consistent with the description of these elements in relation to FIG. 1A and FIG. 1B.

Memory 204 may store a local copy of secure content transfer client (SCTC) 225 for implementing the second device features of the disclosure, by configuring processor to control the above-mentioned hardware and software components of second electronic device 170. In one or more embodiments, SCTC 225 includes program instructions that configure processor 202 to cause the second electronic device 170, after accepting a request to transfer content from the first user device 100, to receive target content along with storage instructions, decryption keys, and embedded metadata, via one or more messages from the first electronic device 100 or from a trusted storage location accessible to the second electronic device 170, such as a cloud server 196. The first electronic device 100 may prompt the second electronic device 170, through transfer instructions or later triggers, to retrieve from the cloud server 196 information such as passwords and encryption keys required by the second electronic device 170 to access and securely store target content received at the second electronic device 170 from the first electronic device 100. Upon receiving the target content, the second electronic device 170 uses the received decryption keys to decrypt the encryption added to facilitate secure transfer and then locally stores the target content at storage device 205 (or on a connected storage device 219, such as an external hard drive) while maintaining the security methods provided with the target content while stored at the first electronic device 100, as indicated in the embedded metadata. Descriptive metadata (e.g., embedded information related to discovery and identification of characteristics of the file or folder) and administrative metadata (e.g. data related to rights and use) may be transferred within a transfer instruction provided with the discreet file transfer process to be used for securely storing the selected content at the second electronic device 170. After the target data is transferred, the second communication device is triggered to extract the additional metadata from the transfer instruction and securely store the selected content, based on the security methods identified by the extracted metadata.

According to one or more embodiments, the first electronic device 100 is configured to effect discrete content transfer. Discreet content transfer is the transfer of content (files or folders or a copy thereof) from the first device 100 to a second electronic device 170 where transfer is secure and where upon receipt at the second device 170 the content is stored using security measures applied to the storage of the original files or folders stored at the first device 100. Discreet content transfer may be initiated by one or more triggers, from among a group comprising: (i) a user selection of a discreet transfer option or application on the first electronic device 100, (ii) the processor identifying that a file selected for transfer is currently being stored in a secure manner and autonomously configuring the device 100 to complete the transfer discreetly, (iii) a device setting that can be pre-programmed as a part of the OS or firmware for file transfer. During discreet content transfer, the first electronic device 100 sends a request to transfer content to the second electronic device 170 via one or more of the data links. Upon receipt of a message from the second electronic device 170 approving the request to transfer content, the first electronic device determines the existing security features applied to the target content at the first device 100. Determining the security features applied to target content at the first device 100 may include, for example, an automated software security auditing tool assessing the security permissions (e.g., New Technology File System (NFTS) or shared permissions) of target files or folders. This process may include scanning the content of target files or folders (individually and collectively referred to herein as content) to identify whether access to such content is restricted, and if so, what type of restriction is currently applied. Relevant access restrictions include but are not limited to password protection, hiding folders, and encryption. Determining whether a file or folder is encrypted may involve determining the entropy of the target file or folder. In determining entropy of target content, an automated tool may assess how orderly or non-random the data contained in the target content is. A high degree of randomness is taken to indicate encryption or compression of the target data. After determining the existing security features applied to the target content at the first electronic device 100, the first electronic device 100 encrypts the target content for secure transfer. Such encryption is separate and apart from encryption existing as part of security features applied to the target content as stored on the first electronic device 100 prior to transfer. Optionally, on-the-fly encryption may be used to facilitate secure transfer of the target content. Regardless of the encryption used, encryption keys may be made available to the second electronic device 170 from the first electronic device 100 in a subsequent message, or from another trusted storage location accessible by the second electronic device 170, such as the cloud server 196. The target content is transferred to the second electronic device 170 along with a transfer instruction provided for discreet file transfer process, the transfer instruction being embedded with metadata to be used for securely storing the selected content at the second electronic device 170 using similar security features as used for the target content on the original electronic device.

FIGS. 3A-3C are example file transfer scenarios presenting exemplary discreet content transfer mode (DCTM) whereby the electronic device transfers targeted content to the second electronic device and stores the targeted content at the second electronic device. Again, discreet content transfer is the transfer of content (files or folders or a copy thereof) from the first device 100 to a second electronic device 170 where transfer is secure and where, upon receipt at the second device 170, the content is stored using security measures applied to the storage of the original files or folder stored at the first device 100. The operations of discreet content transfer, as detailed in relation to the descriptions of FIGS. 1A, 1B, and 2, are automated following the initiation of the content sharing/transfer process by a user of the originating electronic device 100 or 170. Following the automated process, the security features applied to the target content stored at the destination electronic device may be identical to the security features applied to the target content at the originating device prior to the transfer operation. The transfer operation can involve movement of target files/folders (with deletion from original location) or generating and providing copies of the target files/folders to the second electronic device 270. Additionally, the security features applied to the stored target content at the destination device may be preselected by the user of the first electronic device 100 and automatically applied by the second electronic device 170. Additionally or alternatively, the security features applied to the stored target content at the destination device may be automatically applied, without user input, as directed by an AI model 126, which is trained by a dataset that includes data from past transfer operations including target content transfers and/or user tendencies.

FIGS. 3A-3B depict security features applied at the destination device that are identical to the security features applied at the originating device. The transfer and the application of security features are carried out via an automated process after the user 102 of the first device 100 initiates DCTM by performing a drag and drop operation 305, or a copy/cut and paste operation, or a share operation, or other operations indicating a desire to transfer targeted content from electronic device 100 to second electronic device 170. FIG. 3C depicts a scenario where, after DCTM is initiated, via a drag and drop operation 305 for example, user 102 directs electronic device 100 to prompt second device 170 to, in an automated process, apply a security feature at the destination device that differs from the security feature applied to the target content at the originating device.

FIG. 3A illustrates an example file transfer scenario presenting exemplary discreet content transfer mode (DCTM) whereby the electronic device 100 transfers targeted content to the second electronic device 170 and stores the targeted content at the second electronic device 170 without special handling, according to one or more embodiments. In one or more embodiment, user 102 initiates DCTM through implementing a drag and drop operation 305 indicating a desire to transfer selected content from electronic device 100 to electronic device 170. Prior to the transfer of targeted content, data storage 140 of the first electronic device 100 contains an unsecured (e.g., unencrypted) file in an unsecured (unencrypted) folder. Specifically, selected content is shown as a digital storage image file and the transfer is presented as a directional arrow. Image file is depicted without an adjacent lock icon, which indicates that there are no security features applied to the target content before the target content is transferred to the second electronic device 170. The targeted content is also transferred in an unsecure manner. The corresponding security transfer status indicator 350 indicates that the transfer was not secured via a password locking of the file or transfer encryption. Following transfer of the targeted content, data storage 205 of the second electronic device 170 contains the file (or a copy of the file) in a folder. The lack of security features applied to the target content before transfer is mirrored at second device 170.

FIG. 3B illustrates another example file transfer scenario presenting exemplary DCTM whereby the electronic device 100 securely transfers targeted content, that is stored with password protection at the electronic device 100, to the second electronic device 170 and triggers the second electronic device to store the targeted content at the second electronic device 170 with a same password protection, according to one or more embodiments. User 102 initiates DCTM through implementing a drag and drop operation 305 indicating a desire to transfer selected content (or a copy thereof) from electronic device 100 to electronic device 170. Prior to transfer of targeted content, data storage 140 of the first electronic device 100 is shown having a folder containing a file tagged with a lock icon/symbol, with the folder having a string of other symbols included beneath it. This presentation indicates that the target content is password protected on the first electronic device 100, before the content is transferred to the second electronic device 170. As the targeted content is stored securely at the first electronic device, the targeted content is transferred in a secure manner and is then stored at the second electronic device using a similar password. Thus, the corresponding security transfer status 350 indicates that the transfer was secured via encryption as a file, a lock, and an arrow are depicted. Following transfer of the targeted content, data storage 205 of the second electronic device 170 contains a folder containing the file and tagged with a lock icon. The password protection applied to the targeted content before the content was transfer is mirrored post transfer at second device 170.

FIG. 3C illustrates another example file transfer scenario presenting exemplary DCTM whereby the electronic device 100 securely transfers the targeted content to the second electronic device 170 and triggers storage of the targeted content at the second electronic device in a manner different from the manner in which the targeted content was stored at the electronic device 100, according to one or more embodiments. User 102 initiates DCTM through implementing a drag and drop operation 305 indicating a desire to transfer selected content from electronic device 100 to electronic device 170. Following implementation of the drag and drop process 305, user 102 is presented with a user interface 330 with several selectable security options (341-344) for setup and managing of the file transfer process, and more specifically, for masking the path of the file transfer. When selected, selectable security option 341 provides instructions to the second electronic device 170 to trigger the second electronic device 170 to obscure the location of the transferred content by masquerading content as a different type or class of content than is identifiable at the electronic device 100 prior to file transfer. When selected, selectable security option 342 provides instructions to the second electronic device 170 to trigger the second electronic device 170 to obscure the location of the transferred content by assigning a different name to transferred content at the second electronic device 170 than was/is being used to designate/name the content at the electronic device 100. When selected, selectable security option 343 provides instructions to the second electronic device 170 to trigger the second electronic device 170 to hide the selected content or a portion thereof in a data storage device at the second electronic device 170. When selected, selectable security option 344 provides instructions to the second electronic device 170 to trigger the second electronic device 170 to associate the transferred content with an icon different than an icon associated with the targeted content at electronic device 100 prior to file transfer. Here, security option 344 is selected by user 102, indicating a desire to associate the transferred content with an icon at the second device 170, which is a different icon than the icon associated with the targeted content at electronic device 100.

According to the illustrative embodiment, prior to the transfer request, the securely stored targeted content is associated with a depiction of a chess queen and the secure storage of the file is presented as a lock in the rendering of the data storage 140 of electronic device 100. Because the targeted content is stored securely at the first electronic device 100, the targeted content is transferred in a secure manner. The targeted content is also transferred in a secure manner. The corresponding security transfer status indicator 350 indicates that the transfer was secured via a password locking of the file or transfer encryption. Following transfer of the targeted content, data storage 205 of the second electronic device 170 contains a folder containing a file accompanied by a chess pawn and a lock in the rendering of the data storage 205 of the second electronic device 170. This indicates that the target content was protected by being associated with an icon at the destination device that is different from the icon associated with the target content at the originating device.

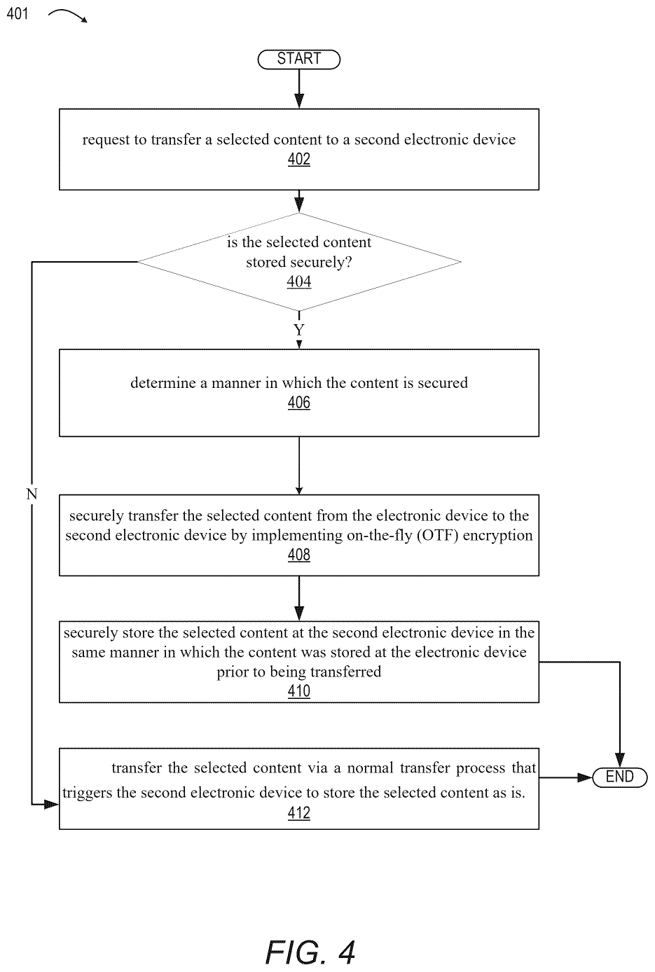

Referring now to the flowchart presented by FIG. 4, the description of the method in FIG. 4 is provided with general reference to the specific components and features illustrated within preceding FIGS. 1A-1B, FIG. 2, and FIGS. 3A-3C. Specific components referenced in the method of FIG. 4 may be identical or similar to components of the same name used in describing preceding FIGS. 1A-1B, FIG. 2, and FIGS. 3A-3C. In one or more embodiments, controller 110 (FIG. 1) is configured to cause the first electronic device 100 (FIGS. 1A and 1B) to provide the described functionality of the method of FIG. 4 by executing program code for one or more modules or applications provided within device data storage 140 of first electronic device 100, including SCTM 125 (FIGS. 1A and 1B).

FIG. 4 depicts a flowchart of a computer-implemented method 400 for discreetly transferring targeted content from a first electronic device 100 and securely storing the content at a second electronic device 170, the content having been initially determined to be securely stored at the first electronic device 100, according to one or more embodiments. Method 400 starts at block 402, where a first electronic device 100 that is communicatively connected to a second electronic device 170 requests to transfer a selected content from the first electronic device 100 to the second electronic device 170. Method 400 continues to block 404, where in response to the request to transfer selected content from the electronic device 100 to the second electronic device 170, the first electronic device 100 determines whether the selected content is stored securely. If it is determined that selected content is not securely stored, method 400 continues to block 412, where the selected content is transferred via a normal transfer process that triggers the second electronic device 170 to store the selected content as is. Then, method 400 ends. If it is determined that that selected content is securely stored, the method continues to block 406, where the first electronic device 100 determines the manner in which the content is secured in storage 141 at the first device 100. Method 400 continues to block 408, where the first electronic device 100 securely transfers the selected content to the second electronic device 170 by implementing on-the-fly (OTF) encryption. Method 400 continues to block 410, where the first electronic device 100 transmits instructions and metadata to trigger the second electronic device 170 to securely store the selected content in the same manner in which the content was stored at the first electronic device 100 prior to the target content being transferred from the first electronic device 100. Then, method 400 ends.

In one or more embodiments, method 400 further includes, in transferring the content via the discreet transfer process, withholding visible notification of the transfer and withholding presentation of a progress status and/or a completion status of the transfer.

In one or more embodiments, method 400 further includes, following receipt of the selected content from the electronic device 100, providing instructions to the second electronic 170 device to trigger the second electronic device to hide the selected content or a portion thereof in a storage device at/associated with the second electronic device 170.

In one or more embodiments, method 400 further comprises, in securely storing the selected content at the second device 170, obscuring the location of the selected content by masquerading the selected content as a different type or class of content.

In one or more embodiments, method 400 further comprises encrypting the selected content with a password prior to the transfer and triggering the second electronic device to decrypt the selected content following the transfer by providing the second electronic device with the decryption key or providing the second electronic device with access to a location from which the decryption key can be retrieved.

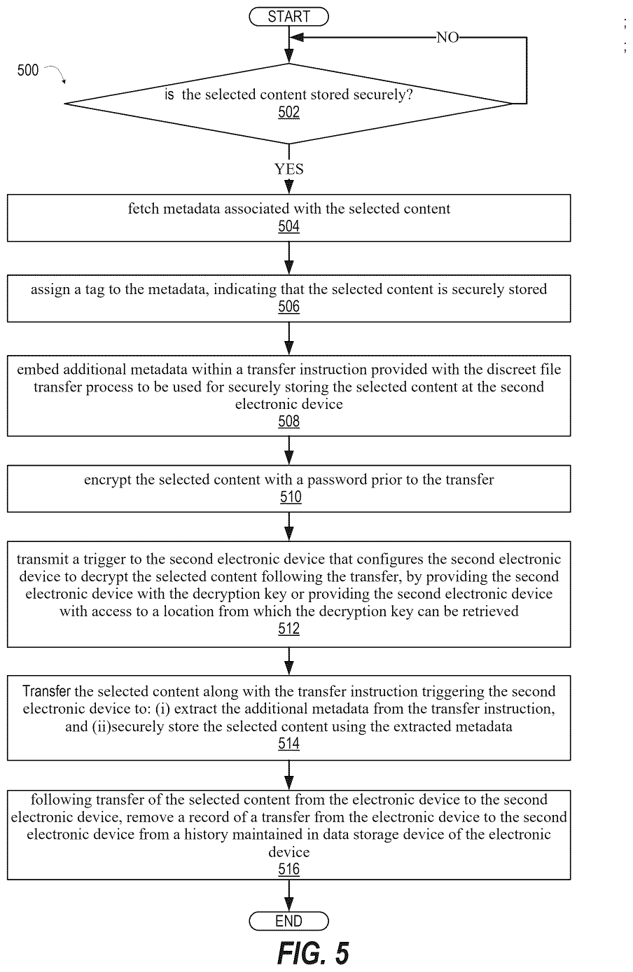

Referring now to the flowchart presented by FIG. 5, the description of the method in FIG. 4 is provided with general reference to the specific components and features illustrated within preceding FIGS. 1A-1B, FIG. 2, and FIGS. 3A-3C. Specific components referenced in the method of FIG. 4 may be identical or similar to components of the same name used in describing preceding FIGS. 1A-1B, FIG. 2, and FIGS. 3A-3E. In one or more embodiments, controller 110 (FIG. 1) is configured to cause the first electronic device 100 (FIGS. 1A and 1B) to provide the described functionality of the method of FIG. 5 by executing program code for one or more modules or applications provided within device data storage 140 of first electronic device 100, including SCTM 125 (FIGS. 1A and 1B).

FIG. 5 depicts a flowchart of a computer-implemented method 500 for discreetly transferring targeted content from a first electronic device 100 and securely storing the content at a second electronic device 170, according to one or more embodiments. Method 500 starts at block 502, where a first electronic device 100 determines whether the selected content is stored using one or more security features at the originating electronic device. If the selected content is determined to be stored securely, method 500 continues to block 504 where the first electronic device 100 fetches metadata associated with the selected content. Method 500 continues to block 506, where the first electronic device 100 assigns a tag to the metadata, indicating that the selected content is securely stored. Method 500 continues to block 508, where the first electronic device 100 embeds additional metadata within a transfer instruction provided with the discreet file transfer process to be used for securely storing the selected content at the second electronic device. Method 500 proceeds to block 510, where the first electronic device 100 encrypts the selected content (e.g., by using a password) prior to the transfer. The method continues to block 512, where the first electronic device transmits a trigger to the second electronic device 170 that configures the second electronic device 170 to decrypt the selected content following the transfer, by providing the second electronic device 170 with the decryption key or providing the second electronic device with access to a location from which the decryption key can be retrieved. Such locations may include, for example, cloud storage 196 or external hard drives 219. Method 500 continues to block 514, where the first electronic device 100 transfers the selected content along with the transfer instruction triggering the second electronic device 170 to: (i) extract the additional metadata from the transfer instruction, and (ii) securely store the selected content using the information retrieved with/within the extracted metadata. Method 500 proceeds to block 516, where the first electronic device 100, following transfer of the selected content from the first electronic device 100 to the second electronic device 170, removes a record of the transfer from the first electronic device 100 to the second electronic device 170 from a history maintained in data storage 140 of the electronic device 100. Then, method 500 ends.

Accordingly, by implementing the above-described processes, a user of an electronic communication device may securely transfer files to a connected second electronic communication device and maintain, in the storage of the content at the second electronic device, a level of security similar to the level of security assigned to the content at the first connected device. The methods disclosed herein allow tailored handling of transferred content between connected devices. The described methods thus provide an improvement in existing technology for discreet transfer of data by allowing a user to customize modifications to the security features applied to target content in order to change or maintain the manner in which files, folders or copies thereof are transferred and stored.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regards to the sequence of operations without departing from the spirit or scope of the present innovation. Use of a particular sequence is therefore, not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display embedded in a user accessible surface of the electronic device;
a communications subsystem comprising an interface that enables the electronic device to communicatively connect via a wireless connection to a second electronic device;
a memory having stored thereon a secure content transfer manager (SCTM) for maintaining security of securely stored content transferred between connected devices; and
at least one processor communicatively coupled to the display, the communications subsystem, and the memory, the at least one processor executing program code of the secure content transfer manager, and configured to cause the electronic device to:
in response to a request to transfer a selected content to the second electronic device, determine whether the selected content is stored securely; and
in response to determining that the selected content is stored securely:
determine a manner in which the content is secured;
transfer the selected content via a discreet transfer process that maintains the security of the content during the transfer from the electronic device to the second electronic device; and
trigger the second electronic device to securely store the selected content at the second electronic device in a same manner in which the content was stored at the electronic device prior to being transferred from the electronic device to the second electronic device.

2. The electronic device of claim 1, the processor further configured to cause the electronic device to:
in response to determining that the selected content is stored securely:
fetch metadata associated with the selected content;
assign a tag to the metadata, indicating that the selected content is securely stored;
embed additional metadata within a transfer instruction provided with a discreet file transfer process to be used for securely storing the selected content at the second electronic device; and
transfer the selected content along with the transfer instruction triggering the second electronic device to:
extract the additional metadata from the transfer instruction; and
securely store the selected content using the extracted metadata.

3. The electronic device of claim 1, the processor being further configured to cause the electronic device to: in response to determining that the selected content is not stored securely, transfer the selected content via a normal transfer process that triggers the second electronic device to store the selected content as is.

4. The electronic device of claim 1, wherein, to transfer the content via the discreet transfer process, the processor configures the electronic device to: securely transfer the selected content from the electronic device to the second electronic device by implementing on-the-fly (OTF) encryption; and withhold visible notification of the transfer and presentation of a progress status and a completion status of the transfer.

5. The electronic device of claim 1, the processor further configured to cause the electronic device to:
following the transfer from the electronic device to the second electronic device, remove a record of the transfer from the electronic device to the second electronic device from a history maintained in a data storage device of the electronic device.

6. The electronic device of claim 1, the processor further configured to cause the electronic device to: provide instructions to the second electronic device to trigger the second electronic device to hide the selected content or a portion thereof in a data storage device at the second electronic device following receipt of the selected content from the electronic device.

7. The electronic device of claim 1, the processor further configured to cause the electronic device to:
in securely storing the selected content at the second device, obscure a location of the content by masquerading content as a different type or class of content.

8. The electronic device of claim 1, the processor further configured to cause the electronic device to:
in securely storing the selected content at the second device, obscure a location of the content by assigning a different name to transferred content at the second electronic device than was used to designate the content at the electronic device.

9. The electronic device of claim 2, the processor further configured to cause the electronic device to:
encrypt the selected content with a password prior to the transfer; and
transmit a trigger to the second electronic device that configures the second electronic device to decrypt the selected content following the transfer, by providing the second electronic device with a decryption key or providing the second electronic device with access to a location from which the decryption key can be retrieved.

10. A method comprising:
in response to a request to transfer a selected content from an electronic device to a second electronic device, determining whether the selected content is stored securely; and
in response to determining that the selected content is stored securely:
determining a manner in which the content is secured;
transferring the selected content via a discreet transfer process that maintains the security of the content during transferring from the electronic device to the second electronic device; and
securely storing the selected content at the second electronic device in a same manner in which the content was stored at the electronic device prior to being transferred.

11. The method of claim 10, further comprising:
in response to determining that the selected content is stored securely:
fetching metadata associated with the selected content;
assigning a tag to the metadata, indicating that the selected content is securely stored;
embedding additional metadata within a transfer instruction provided with a discreet file transfer process to be used for securely storing the selected content at the second electronic device; and
transferring the selected content along with the transfer instruction triggering the second electronic device to:
extract the additional metadata from the transfer instruction; and
securely store the selected content using the extracted metadata.

12. The method of claim 10, further comprising:
in response to determining that the selected content is not stored securely, transferring the selected content via a normal transfer process that triggers the second electronic device to store the selected content as is.

13. The method of claim 10, wherein transferring the content via the discreet transfer process comprises: securely transferring the selected content from the electronic device to the second electronic device by implementing on-the-fly (OTF) encryption; and withholding visible notification of the transfer and presentation of a progress status and a completion status of the transfer.

14. The method of claim 10, further comprising:
following transfer of the selected content from the electronic device to the second electronic device, removing a record of a transfer from the electronic device to the second electronic device from a history maintained in a data storage device of the electronic device.

15. The method of claim 10, further comprising:
following receipt of the selected content from the electronic device, providing instructions to the second electronic device to trigger the second electronic device to hide the selected content or a portion thereof in a data storage device at the second electronic device.

16. The method of claim 10, further comprising:
in securely storing the selected content at the second device, obscuring a location of the selected content by masquerading the selected content as a different type or class of content.

17. The method of claim 11, further comprising:
encrypting the selected content with a password prior to the transfer, and decrypting the selected content following the transfer, by providing the second electronic device with a decryption key or providing the second electronic device with access to a location from which the decryption key can be retrieved.

18. A computer program product comprising a non-transitory computer readable medium having program instructions that when executed by a processor of an electronic device communicatively connected via a wireless connection to a second electronic device, configure the electronic device to perform functions comprising:
in response to a request to transfer a selected content from an electronic device to a second electronic device, determining whether the selected content is stored securely; and
in response to determining that the selected content is stored securely:
determining a manner in which the content is secured;
transferring the selected content via a discreet transfer process that maintains the security of the content during transfer from the electronic device to the second electronic device; and
securely storing the selected content at the second electronic device in a same manner in which the content was stored at the electronic device prior to being transferred.

19. The computer program product of claim 18, further comprising program instructions that configure the electronic device to complete processes comprising:
in response to determining that the selected content is stored securely:
fetching metadata associated with the selected content;
assigning a tag to the metadata, indicating that the selected content is securely stored;
embedding additional metadata within a transfer instruction provided with a discreet file transfer process to be used for securely storing the selected content at the second electronic device; and
transferring the selected content along with the transfer instruction triggering the second electronic device to:
extract the additional metadata from the transfer instruction; and
securely store the selected content using the extracted metadata.

20. The computer program product of claim 18, further comprising program instructions that configure the electronic device to complete processes comprising:
following transfer of the selected content from the electronic device to the second electronic device, removing a record of a transfer from the electronic device to the second electronic device from a history maintained in a data storage device of the electronic device.
